(19) United States
(12) Patent Application Publication
(10) Pub. No.: US 2021/0296827 A1
(43) Pub. Date: Sep. 23, 2021

(54) FIRST CONNECTOR, SECOND CONNECTOR, AND CONNECTOR DEVICE

(71) Applicant: SAKAI DISPLAY PRODUCTS CORPORATION, Sakai-shi, Osaka (JP)

(72) Inventor: KOHJI NAGASAKA, Sakai-shi, Osaka (JP)

(21) Appl. No.: 17/255,363

(22) PCT Filed: Jul. 4, 2018
(86) PCT No.: PCT/JP2018/025375

§ 371 Date: Apr. 2, 2021

(51) Int. Cl. H01R 13/648; H01R 13/652

(52) U.S. Cl. CPC H01R 13/6485; H01R 13/652

(57) ABSTRACT

A first connector is connected to a second connector. The first connector is provided with a first frame body, first signal terminals, and a grounded part. The first frame body has a first opening. The second connector is inserted in the first frame body through the first opening. The first signal terminals are disposed inside the first frame body so as to be brought into connection with second signal terminals that are provided to the second connector. The grounded part is disposed in such a manner as to come into contact with the second signal terminals after initiation of insertion of the second connector into the first frame body and before establishment of a connection state where, upon completion of the insertion, the first signal terminals and the second signal terminals come to be connected respectively, and also to separate away from the second signal terminals in the connection state.

### TECHNICAL FIELD

The present invention relates to a first connector, a second connector, and a connector device.

### BACKGROUND ART

A receptor according to Patent Literature 1 is defined by an interface standard through which data is transferred using differential signaling. The receptor transmits a signal by being connected to a plug. Specifically, the receptor includes a power terminal, a ground terminal, a first differential signal terminal which transmits a first differential signal, a second differential signal terminal which transmits a second differential signal, and a protective element.

The protective element is provided between the power terminal and the ground terminal. The protective element protects an electronic device to which the receptor is installed from transient voltage or static electricity incurring from outside of the power terminal or the ground terminal of the receptor. The protective element is made from a chip capacitor and a Zener diode. The Zener diode can be replaced with a varistor.

### CITATION LIST

### Patent Literature

[Patent Literature 1]

Japanese Patent Application Laid-Open Publication No. 2005-222855

### SUMMARY OF INVENTION

### Technical Problem

However, the receptor disclosed in Patent Literature 1 requires electronic components such as the chip capacitor and the Zener diode. Accordingly, the manufacturing cost of the receptor (one type of connector) increases in order to protect the electronic device to which the receptor is installed from electrostatic discharge (ESD).

An object of the present invention is to provide a first connector, a second connector, and a connector device capable of being produced at reduced manufacturing cost while protecting an electronic device from electrostatic discharge.

### Solution to Problem

A first connector according to one aspect of the present invention is to be connected to a second connector. The first connector includes a first frame body, a first signal terminal, and a grounded part. The first frame body includes a first opening. The second connector is inserted into the first frame body through the first opening. The first signal terminal is arranged inside of the first frame body and is connected to a second signal terminal included in the second connector. The grounded part is arranged to make contact with the second signal terminal after insertion of the second connector to the first frame body has begun but before a connected state is reached in which the first signal terminal and the second signal terminal are connected at completion of the insertion, and separate from the second signal terminal in the connected state.

A second connector according to another aspect of the present invention is to be connected to the above first connector. The second connector includes the second signal terminal. The second signal terminal makes contact with the grounded part after insertion of the second connector to the first frame body has begun but before the connected state is reached, and is separated from the grounded part in the connected state.

A connector device according to yet another aspect of the present invention includes the above first connector and the above second connector.

### Advantageous Effects of Invention

According to the present invention, manufacturing cost can be reduced while an electronic device can be protected from electrostatic discharge.

### BRIEF DESCRIPTION OF DRAWINGS

FIG. 1 is a perspective view of a first connector of a connector device according to a first embodiment of the present invention.

FIG. 2 is a plan view of the first connector of the connector device according to the first embodiment.

FIG. 3 is a cross-sectional view of the first connector of the connector device according to the first embodiment.

FIG. 4 is a perspective view of a second connector of the connector device according to the first embodiment.

FIG. 5 is a plan view of the second connector of the connector device according to the first embodiment.

FIG. 6 is a cross-sectional view of the second connector of the connector device according to the first embodiment.

FIG. 7(a) is a schematic cross-sectional view of a state in which the first connector and the second connector of the connector device are separated according to the first embodiment. FIG. 7(b) is a schematic cross-sectional view of a state in which the first connector and the second connector of the connector device are being connected according to the first embodiment. FIG. 7(c) is a schematic cross-sectional view of a connected state in which the first connector and the second connector of the connector device are connected according to the first embodiment.

FIG. 8(a) is a schematic plan view of the state in which the first connector and the second connector of the connector device are separated according to the first embodiment. FIG. 8(b) is a schematic plan view of the state in which the first connector and the second connector of the connector device are being connected according to the first embodiment. FIG. 8(c) is a schematic plan view of the connected state in which the first connector and the second connector of the connector device are connected according to the first embodiment.

FIG. 9(a) is a schematic cross-sectional view of a state in which the first connector and the second connector of the connector device are being connected according to a first variation of the first embodiment. FIG. 9(b) is a schematic cross-sectional view of a connected state in which the first connector and the second connector of the connector device are connected according to the first variation of the first embodiment.

FIG. 10(a) is a schematic cross-sectional view of a state in which the first connector and the second connector of the connector device are being connected according to a second variation of the first embodiment. FIG. 10(b) is a schematic cross-sectional view of a connected state in which the first connector and the second connector of the connector device are connected according to the second variation of the first embodiment.

FIG. 11 is a perspective view of a first connector of a connector device according to a second embodiment of the present invention.

FIG. 12 is a cross-sectional view of the first connector of the connector device according to the second embodiment.

FIG. 13(a) is a schematic cross-sectional view of a state in which the first connector and a second connector of the connector device are separated according to the second embodiment. FIG. 13(b) is a schematic cross-sectional view of a state in which the first connector and the second connector of the connector device are being connected according to the second embodiment. FIG. 13(c) is a schematic cross-sectional view of a connected state in which the first connector and the second connector of the connector device are connected according to the second embodiment.

FIG. 14(a) is a schematic cross-sectional view of a state in which the first connector and the second connector of the connector device are being connected according to a first variation of the second embodiment. FIG. 14(b) is a schematic cross-sectional view of a connected state in which the first connector and the second connector of the connector device are connected according to the first variation of the second embodiment.

FIG. 15(a) is a schematic cross-sectional view of a state in which the first connector and the second connector of the connector device are being connected according to a second variation of the second embodiment. FIG. 15(b) is a schematic cross-sectional view of a connected state in which the first connector and the second connector of the connector device are connected according to the second variation of the second embodiment.

FIG. 16 is a cross-sectional view of the first connector of the connector device according to a third variation of the second embodiment.

### DESCRIPTION OF EMBODIMENTS

The following describes embodiments of the present invention with reference to the accompanying drawings. Note that elements that are the same or equivalent are labeled with the same reference signs in the drawings and description thereof is not repeated. To facilitate understanding, X, Y, and Z axes of a three-dimensional coordinate system are appropriately shown in the drawings.

### First Embodiment

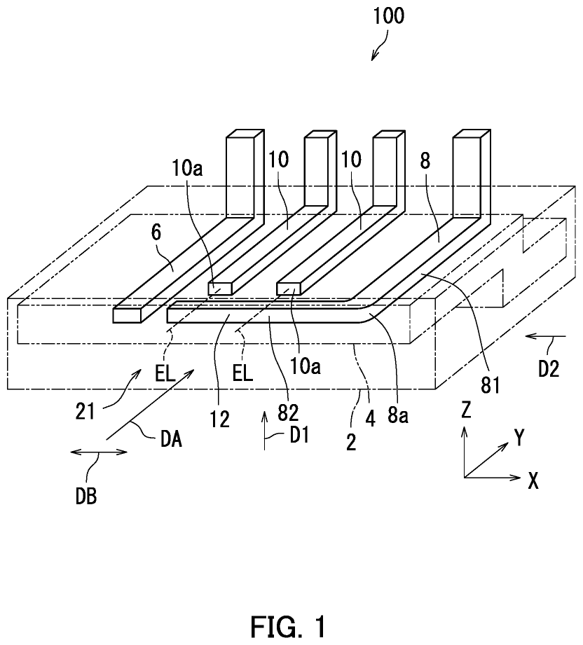

A connector device (referred to in the following as a “connector device 1”) according to a first embodiment of the present invention is described with reference to FIGS. 1 to 8(c). The connector device 1 realizes an electrical connection. First, the connector device 1 is described with reference to FIGS. 1 to 6.

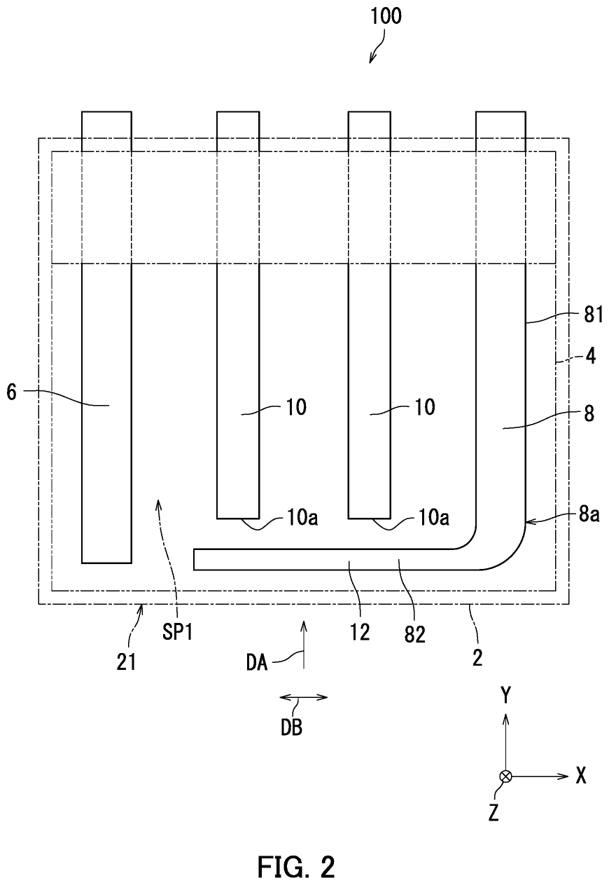

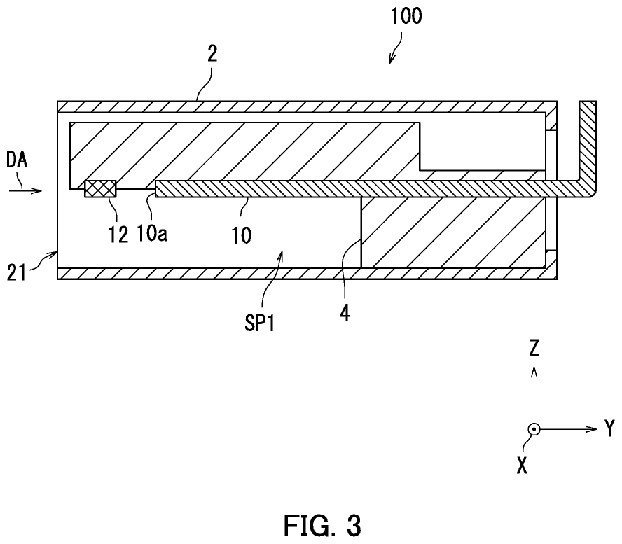

FIG. 1 is a perspective view of a first connector 100 of the connector device 1. FIG. 2 is a plan view of the first connector 100. In FIG. 2, the first connector 100 is viewed in a direction D1 in FIG. 1. FIG. 3 is a cross-sectional view of the first connector 100. FIG. 3 illustrates a cross section of the first connector 100 as viewed in a direction D2 in FIG. 1.

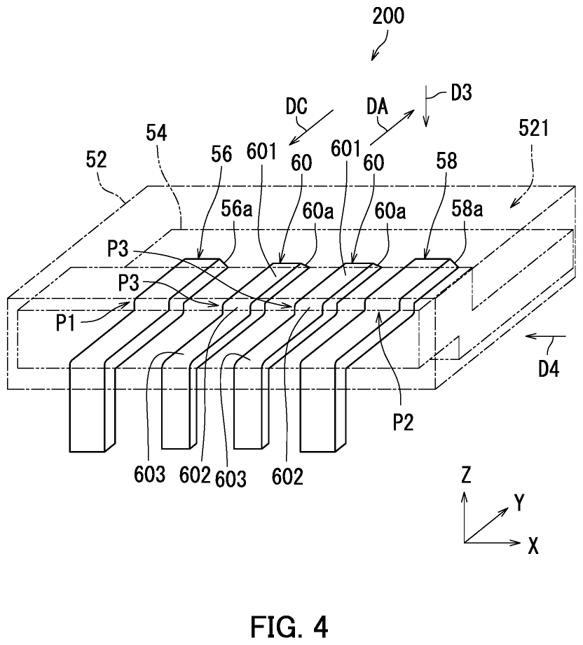

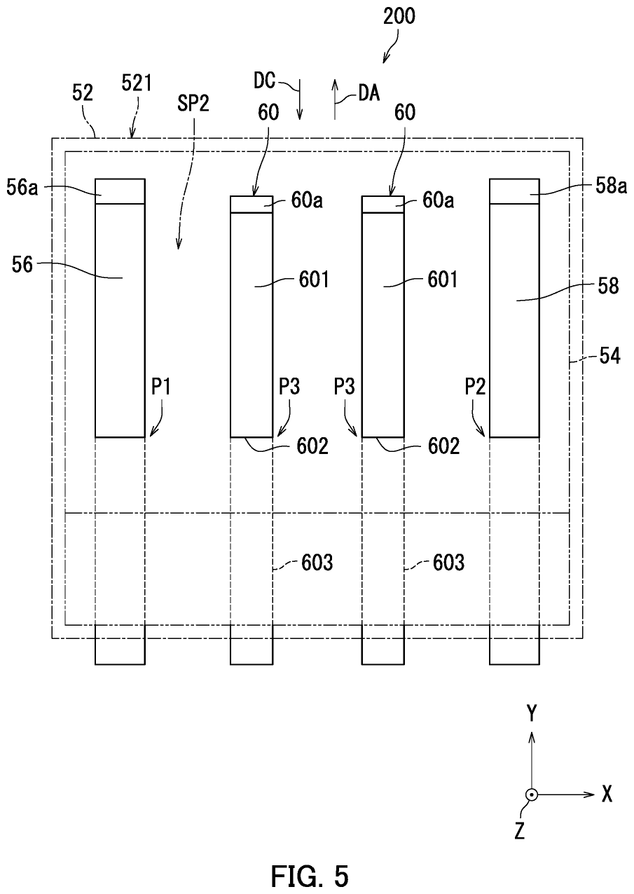

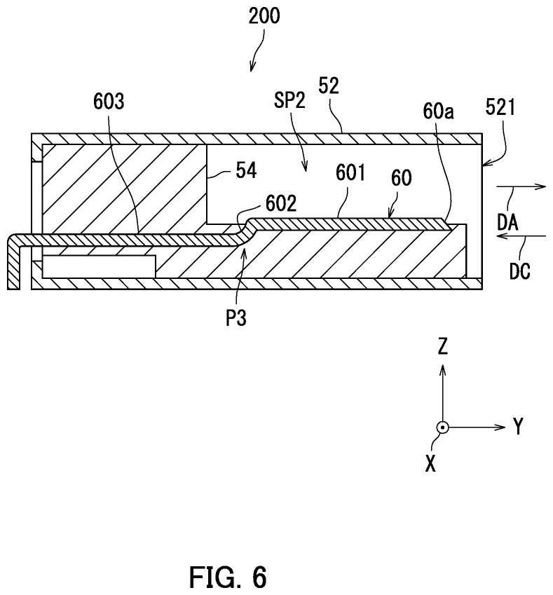

FIG. 4 is a perspective view of a second connector 200 of the connector device 1. FIG. 5 is a plan view of the second connector 200. In FIG. 5, the second connector 200 is viewed in a direction D3 in FIG. 4. FIG. 6 is a cross-sectional view of the second connector 200. FIG. 6 illustrates a cross section of the second connector 200 as viewed in a direction D4 in FIG. 4.

As illustrated in FIGS. 1 and 4, the connector device 1 includes the first connector 100 and the second connector 200. The first connector 100 is electrically connected to the second connector 200. In other words, the second connector 200 is electrically connected to the first connector 100. Accordingly, the first connector 100 and the second connector 200 are electrical connectors. Specifically, the second connector 200 is moved in a first direction DA to be fitted to the first connector 100. The second connector 200 is then electrically connected to the first connector 100. The first direction DA corresponds to an “insertion direction of the second connector 200”.

Next, the first connector 100 is described with reference to FIGS. 1 to 3. As illustrated in FIGS. 1 to 3, the first connector 100 includes a first frame body 2, a first holding body 4, a first power terminal 6, a first ground terminal 8, a plurality of first signal terminals 10, and a grounded part 12.

In the first embodiment, the first connector 100 includes two first signal terminals 10. Also in the first embodiment, the first connector 100 is a type-A receptor conforming to the Universal Serial Bus (USB) standard. Note that in FIGS. 1 and 2, the first frame body 2 is illustrated as a dashed and dotted line and the first holding body 4 is illustrated as a dashed and double dotted line to facilitate viewing of the drawings.

The first frame body 2 is hollow and is a substantial rectangular parallelepiped. The first frame body 2 is substantially square tube-shaped, for example. The material of the first frame body 2 is a conductive material. The first frame body 2 is made of metal, for example. The first frame body 2 is grounded, for example. The first frame body 2 has a substantially rectangular first opening 21. The second connector 200 is inserted into the first frame body 2 through the first opening 21. Specifically, the second connector 200 passes through the first opening 21 in the first direction DA when the second connector 200 is connected to the first connector 100.

The first direction DA is substantially orthogonal to the first opening 21. Here, for convenience of description in the first embodiment, a side on which the first opening 21 is located is forward or a front side of the first connector 100, and a side opposite to the first opening 21 is backward or a back side of the first connector 100. Note that a back end part of the first frame body 2 is covered with a synthetic resin cover (unillustrated).

The first holding body 4 is step-shaped with a single step. That is, the first holding body 4 has a shape in which two substantially rectangular plates have been offset in the first direction DA and joined. The material of the first holding body 4 is an electrically insulating material. The first holding body 4 is made of synthetic resin, for example. The first holding body 4 is arranged inside the first frame body 2.

The material of the first power terminal 6, the first signal terminals 10, and the first ground terminal 8 is a conductive material. The first power terminal 6, the first signal terminals 10, and the first ground terminal 8 are made of metal, for example.

The first power terminal 6, the first signal terminals 10, and the first ground terminal 8 are arranged inside the first frame body 2. The first power terminal 6, the first signal terminals 10, and the first ground terminal 8 are arranged substantially parallel to each other with spaces therebetween. The first signal terminals 10 are arranged between the first power terminal 6 and the first ground terminal 8.

The first power terminal 6, the first signal terminals 10, and the first ground terminal 8 are held by the first holding body 4. As illustrated in FIGS. 2 and 3, a portion of each of the first power terminal 6, the first signal terminals 10, and the first ground terminal 8 is exposed from the first holding body 4 in an internal space SP1 of the first frame body 2. As such, a portion of each of the first power terminal 6, the first signal terminals 10, and the first ground terminal 8 is positioned on the side of the first opening 21. Note that FIG. 3 illustrates a cross section of the first signal terminals 10 and the grounded part 12 taken in parallel to a YZ plane.

The first power terminal 6, the first signal terminals 10, and the first ground terminal 8 extend inside the first frame body 2 from the side of the first opening 21 in a direction away from the first opening 21. In other words, the first power terminal 6, the first signal terminals 10, and the first ground terminal 8 extend inside the first frame body 2 from the side of the first opening 21 along the first direction DA. In yet other words, the first power terminal 6, the first signal terminals 10, and the first ground terminal 8 extend inside the first frame body 2 along the first direction DA. In the present description, “along the first direction DA” means “substantially in parallel to the first direction DA”.

A power supply voltage is applied to the first power terminal 6. The first ground terminal 8 is grounded. When the first ground terminal 8 is grounded, the first ground terminal 8 has a ground potential. A signal voltage is applied to each of the first signal terminals 10. In the first embodiment, one signal voltage (D+) of two signal voltages composing a differential signal is applied to one first signal terminal 10 of the two first signal terminals 10, and the other signal voltage (D−) is applied to the other first signal terminal 10.

The first ground terminal 8 has an end 8a. The end 8a is an end on the side of the first opening 21 among the two ends of the first ground terminal 8. Each of the first signal terminals 10 has an end 10a. The end 10a is an end on the side of the first opening 21 among the two ends of the first signal terminal 10.

The grounded part 12 is grounded. When the grounded part 12 is grounded, the grounded part 12 has a ground potential. The grounded part 12 is a flat substantially plate-shaped member. The material of the grounded part 12 is a conductive material. The grounded part 12 is made of metal, for example. The grounded part 12 extends from the end 8a of the first ground terminal 8 so as to pass between the ends 10a of the first signal terminals 10 and the first opening 21. The grounded part 12 is arranged in an area of extension where the first signal terminals 10 are extended along the first direction DA, toward the first opening 21 from the ends 10a on the first opening 21 side of the first signal terminals 10. In the following, the “area of extension” relative to the first signal terminals 10 is referred to as an “extension area EA”. In the first embodiment, the grounded part 12 is arranged to intersect with an extension line EL of each of the first signal terminals 10. The extension line EL extends along the first direction DA, toward the first opening 21 from the end 10a on the first opening 21 side of each of the first signal terminals 10. The extension line EL is a line inside the extension area EA.

Specifically, the grounded part 12 bends from the end 8a of the first ground terminal 8 and extends so as to pass between the ends 10a of the first signal terminals 10 and the first opening 21. More specifically, the grounded part 12 bends in a substantial right angle from the end 8a of the first ground terminal 8 and extends so as to pass between the ends 10a of the first signal terminals 10 and the first opening 21. Accordingly, the grounded part 12 extends along a direction DB. The grounded part 12 is arranged between the first opening 21 and the ends 10a of the first signal terminals 10. The direction DB is a direction substantially orthogonal to the first direction DA and is a direction toward the first power terminal 6 from the first ground terminal 8. Note that the first power terminal 6, the first signal terminals 10, and the first ground terminal 8 are arranged along the direction DB.

In the first embodiment, the grounded part 12 is configured as a portion of the first ground terminal 8. That is, the grounded part 12 and the first ground terminal 8 are an integrated piece. Accordingly, the number of components in the first connector 100 can be reduced. As a result, the manufacturing cost of the first connector 100 can be reduced. As illustrated in FIG. 2, the integrated piece made of the grounded part 12 and the first ground terminal 8 is substantially L-shaped as viewed in plan.

Specifically, the first ground terminal 8 includes a first part 81 and a second part 82. The first part 81 extends along the first direction DA. The second part 82 extends from the end 8a on the first opening 21 side of the first part 81 so as to pass between the first signal terminals 10 and the first opening 21. The second part 82 of the first ground terminal 8 composes the grounded part 12.

Next, the second connector 200 is described with reference to FIGS. 4 to 6. As illustrated in FIGS. 4 to 6, the second connector 200 includes a second frame body 52, a second holding body 54, a second power terminal 56, a second ground terminal 58, and a plurality of second signal terminals 60. The second signal terminals 60 are provided correspondingly to the first signal terminals 10 of the first connector 100. The second signal terminals 60 are connected to the respective first signal terminals 10.

In the first embodiment, the second connector 200 includes two second signal terminals 60 corresponding to the two respective first signal terminals 10. In the first embodiment, the second connector 200 is a type-A plug conforming to the USB standard. Note that in FIGS. 4 and 5, the second frame body 52 is illustrated as a dashed and dotted line and the second holding body 54 is illustrated as a dashed and double dotted line to facilitate viewing of the drawings.

The second frame body 52 is hollow and is a substantial rectangular parallelepiped. The second frame body 52 is substantially square tube-shaped, for example. The material of the second frame body 52 is a conductive material. The second frame body 52 is made of metal, for example. The second frame body 52 is grounded, for example. The second frame body 52 has a substantially rectangular second opening 521.

Here, for convenience of description in the first embodiment, a side on which the second opening 521 is located is forward or a front side of the second connector 200, and a side opposite to the second opening 521 is backward or a back side of the second connector 200. Note that a back end part of the second frame body 52 is covered with a synthetic resin cover (unillustrated).

The second holding body 54 is step-shaped with a single step. That is, the second holding body 54 has a shape in which two substantially rectangular plates have been offset in the first direction DA and joined. The material of the second holding body 54 is an electrically insulating material. The second holding body 54 is made of synthetic resin, for example. The second holding body 54 is arranged inside the second frame body 52.

The material of the second power terminal 56, the second signal terminals 60, and the second ground terminal 58 is a conductive material. The second power terminal 56, the second signal terminals 60, and the second ground terminal 58 are made of metal, for example.

The second power terminal 56, the second signal terminals 60, and the second ground terminal 58 are arranged inside the second frame body 52. The second power terminal 56, the second signal terminals 60, and the second ground terminal 58 are arranged substantially in parallel to each other with spaces therebetween. The second signal terminals 60 are arranged between the second power terminal 56 and the second ground terminal 58.

The second power terminal 56, the second signal terminals 60, and the second ground terminal 58 are held by the second holding body 54. Further, as illustrated in FIGS. 5 and 6, a portion of each of the second power terminal 56, the second signal terminals 60, and the second ground terminal 58 is exposed from the second holding body 54 in an internal space SP2 of the second frame body 52. As such, a portion of each of the second power terminal 56, the second signal terminals 60, and the second ground terminal 58 is positioned on the side of the second opening 521. Note that FIG. 6 illustrates a cross section of the second signal terminal 60 taken in parallel to the YZ plane.

The second power terminal 56, the second signal terminals 60, and the second ground terminal 58 extend inside the second frame body 52 from the side of the second opening 521 in a direction away from the second opening 521. In other words, the second power terminal 56, the second signal terminals 60, and the second ground terminal 58 extend inside the second frame body 52 from the side of the second opening 521 along a second direction DC which is opposite to the first direction DA. In yet other words, the second power terminal 56, the second signal terminals 60, and the second ground terminal 58 extend inside the second frame body 52 along the first direction DA.

Inside the second frame body 52, the second power terminal 56 bends at a prescribed position P1 to go into and across the second holding body 54 and extends in a direction away from the second opening 521. The second power terminal 56 has an end 56a. The end 56a is an end on the side of the second opening 521 among the two ends of the second power terminal 56. The end 56a is inclined at an acute angle relative to the first direction DA. The prescribed position P1 is a position farther from the second opening 521 than the end 56a of the second power terminal 56. A power supply voltage is applied to the second power terminal 56.

Inside the second frame body 52, the second ground terminal 58 bends at a prescribed position P2 to go into and across the second holding body 54 and extends in a direction away from the second opening 521. The second ground terminal 58 has an end 58a. The end 58a is an end on the side of the second opening 521 among the two ends of the second ground terminal 58. The end 58a is inclined at an acute angle relative to the first direction DA. The prescribed position P2 is a position farther from the second opening 521 than the end 58a of the second ground terminal 58. The second ground terminal 58 is grounded. When the second ground terminal 58 is grounded, the second ground terminal 58 has a ground potential.

Inside the second frame body 52, the second signal terminals 60 bend at prescribed positions P3 to go into and across the second holding body 54 and extend in a direction away from the second opening 521. That is, inside the second frame body 52, the second signal terminals 60 bend at the prescribed positions P3 to go into and across the second holding body 54 and extend along the second direction DC. Each of the second signal terminals 60 has an end 60a. The end 60a is an end on the side of the second opening 521 among the two ends of the second signal terminal 60. The end 60a is inclined at an acute angle relative to the first direction DA. The prescribed positions P3 are positions farther from the second opening 521 than the ends 60a of the second signal terminals 60.

Specifically, the second signal terminals 60 each include a substantially linear contact part 601, a bending part 602, and a substantially linear non-contact part 603. The contact parts 601 are exposed in the internal space SP2 of the second frame body 52. The contact parts 601 make contact with the respective first signal terminals 10 of the first connector 100 in a connected state (referred to in the following as a “connected state CS”) in which the first connector 100 and the second connector 200 are connected. The connected state CS is a state in which the first connector 100 and the second connector 200 are fitted to each other and the first connector 100 and the second connector 200 are completely connected. Accordingly, the connected state CS does not include a state in which the first connector 100 and the second connector 200 are being connected even when the first connector 100 and the second connector 200 are in contact.

In the connected state CS, the non-contact parts 603 are separated from the first signal terminals 10 (refer to FIG. 3) of the first connector 100 and out of contact with the first signal terminals 10. The bending parts 602 bend at the prescribed positions P3 and connect the contact parts 601 to the non-contact parts 603.

Signal voltages are applied to the second signal terminals 60. In the first embodiment, one signal voltage (D+) of two signal voltages composing a differential signal is applied to one second signal terminal 60 of the two second signal terminals 60, and the other signal voltage (D−) is applied to the other second signal terminal 60.

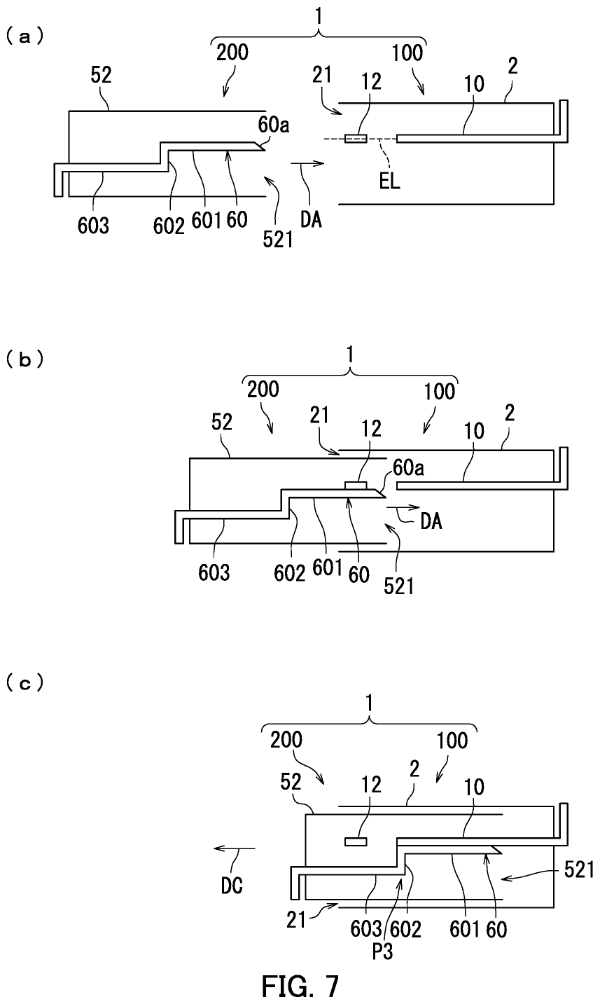

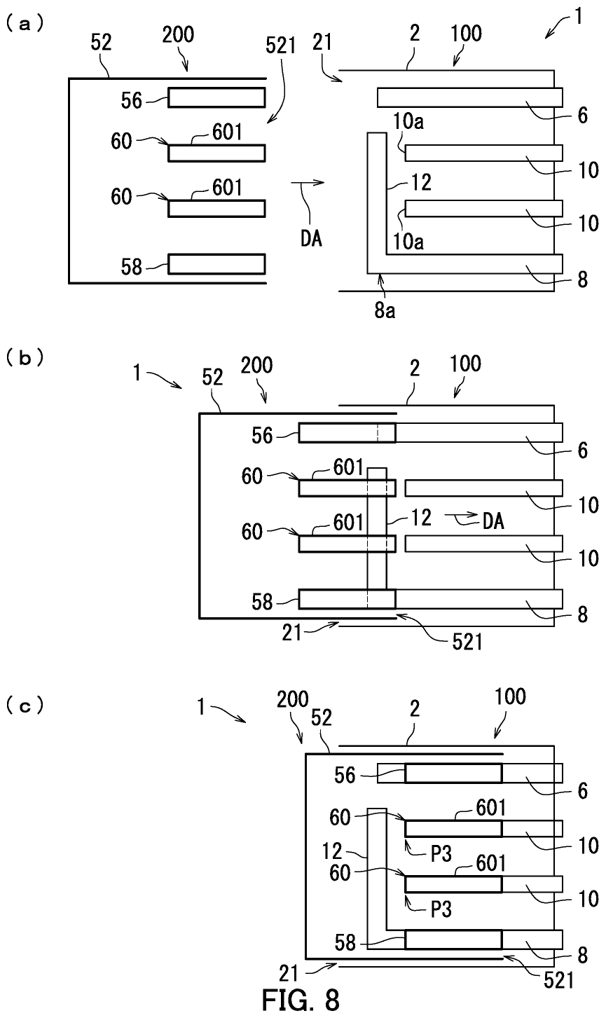

Next, a process from a state in which the first connector 100 and the second connector 200 are separated to the connected state CS is described with reference to FIGS. 7(a) to 8(c). FIGS. 7(a) and 8(a) are respectively a schematic cross-sectional view and a plan view of the state in which the first connector 100 and the second connector 200 are separated. FIGS. 7(b) and 8(b) are respectively a schematic cross-sectional view and a plan view of a state in which the first connector 100 and the second connector 200 are being connected. FIGS. 7(c) and 8(c) are respectively a schematic cross-sectional view and a plan view of the connected state CS in which the first connector 100 and the second connector 200 are connected. Note that in FIGS. 7(a) to 8(c), the first holding body 4 and the second holding body 54 are omitted to facilitate viewing of the drawings. Furthermore, in FIGS. 8(a) to 8(c), the second connector 200 is illustrated by a thick line to clearly differentiate the second connector 200 from the first connector 100.

As illustrated in FIGS. 7(a) and 8(a), the first connector 100 and the second connector 200 are separated. The second connector 200 is then moved in the first direction DA toward the first connector 100.

Then, as illustrated in FIGS. 7(b) and 8(b), the second signal terminals 60 of the second connector 200 pass through the first opening 21 of the first connector 100. By contrast, the grounded part 12 of the first connector 100 is arranged on the side of the first opening 21 relative to the first signal terminals 10. Accordingly, the grounded part 12 makes contact with the second signal terminals 60 before the first signal terminals 10 make contact with the second signal terminals 60.

Specifically, the grounded part 12 makes contact with the second signal terminals 60 after insertion of the second connector 200 to the first frame body 2 has begun but before a connected state is reached in which the first signal terminals 10 and the second signal terminals 60 are connected at completion of the insertion. In other words, the second signal terminals 60 make contact with the grounded part 12 after the insertion of the second connector 200 to the first frame body 2 has begun but before the connected state is reached.

Therefore, according to the first embodiment, in a case in which the second signal terminals 60 are carrying static electricity, electric charge caused by the static electricity of the second signal terminals 60 can be discharged through the grounded part 12 before the first signal terminals 10 make contact with the second signal terminals 60. As a result, the electronic device to which the first connector 100 is installed can be protected from electrostatic discharge, electrostatic discharge is a phenomenon in which discharge of static electricity occurs when charged objects make contact with each other. Note that a connected state in which the first signal terminals 10 and the second signal terminals 60 are connected is substantively the connected state CS. Accordingly, the connected state in which the first signal terminals 10 and the second signal terminals 60 are connected is also referred to as a “connected state CS”.

In addition, in the first embodiment, it is sufficient that the grounded part 12 be included in the first connector 100 as a component for protecting the electronic device from electrostatic discharge. Accordingly, the first connector 100 and the second connector 200 are not required to include electronic components (a chip capacitor, a Zener diode, a varistor, and the like) for countering electrostatic discharge. Furthermore, work to electrically connect electronic components for countering electrostatic discharge is not required. As a result, the manufacturing cost of the first connector 100 and the second connector 200 can be reduced. In other words, the manufacturing cost of the connector device 1 can be reduced.

According to the first embodiment as described above with reference to FIGS. 7(b) and 8(b), the manufacturing cost of the first connector 100 and the second connector 200 can be reduced while protecting the electronic device to which the first connector 100 is installed from electrostatic discharge. In other words, the manufacturing cost of the connector device 1 can be reduced while protecting the electronic device to which the first connector 100 is installed from electrostatic discharge. Furthermore, because it is not required to secure a location at which an electronic component for countering electrostatic discharge is to be electrically connected, electrostatic discharge can be easily countered by the grounded part 12.

Note the grounded part 12 and the second signal terminals 60 make contact with each other due to elasticity of the grounded part 12 and the second signal terminals 60.

Furthermore, in the first embodiment, the ends 60a of the second signal terminals 60 are inclined. Accordingly, the second signal terminals 60 (specifically the ends 60a) can advance in the first direction DA while smoothly making contact with the grounded part 12.

Additionally, in the first embodiment as illustrated in FIG. 8(a), the grounded part 12 extends from the end 8a of the first ground terminal 8 so as to pass between the first opening 21 and the ends 10a of the first signal terminals 10. Accordingly, as illustrated in FIG. 8(b), the second signal terminals 60 easily make contact with the grounded part 12 before making contact with the first signal terminals 10. As a result, electric charge caused by static electricity of the second signal terminals 60 can be easily discharged through the grounded part 12, and the electronic device to which the first connector 100 is installed can be protected from electrostatic discharge. In particular, the second signal terminals 60 can be more easily brought into contact with the grounded part 12 before the first signal terminals 10 make contact with the second signal terminals 60 because the grounded part 12 is arranged in the extension area EA (on the extension line EL in the first embodiment) from the first signal terminals 10 (FIGS. 1 and 7(a)). As a result, electric charge caused by static electricity of the second signal terminals 60 can be more easily discharged through the grounded part 12. Note that when the grounded part 12 and the second signal terminals 60 are in contact, the grounded part 12 intersects with the second signal terminals 60. Specifically, the grounded part 12 is substantially orthogonal to the second signal terminals 60.

Referring again to FIGS. 7(b) and 8(b), when the second signal terminals 60 make contact with the grounded part 12, the second power terminal 56 makes contact with the first power terminal 6 and the second ground terminal 58 makes contact with the first ground terminal 8. Note that in the state of the connector device 1 of FIG. 8(b), the second power terminal 56 may not make contact with the first power terminal 6 and the second ground terminal 58 may not make contact with the first ground terminal 8.

When the second connector 200 is further moved in the first direction DA, the state of the connector device 1 becomes the connected state CS in which the first connector 100 and the second connector 200 are connected as illustrated in FIGS. 7(c) and 8(c).

That is, in the connected state CS, the second power terminal 56 is in contact with the first power terminal 6 and the second ground terminal 58 is in contact with the first ground terminal 8. In other words, in the connected state CS, the first power terminal 6 is connected to the second power terminal 56 and the first ground terminal 8 is connected to the second ground terminal 58. In addition, the grounded part 12 is arranged to be separated from the second signal terminals 60 in the connected state CS in which the first signal terminals 10 and the second signal terminals 60 are connected. In other words, the second signal terminals 60 are separated from the grounded part 12 in the connected state CS.

Therefore, according to the first embodiment, even when the first connector 100 includes the grounded part 12, the signal voltages can be transmitted from the first signal terminals 10 to the second signal terminals 60 and the signal voltages can be transmitted from the second signal terminals 60 to the first signal terminals 10 in the connected state CS.

Note that the first signal terminals 10 and the second signal terminals 60 make contact with each other due to the elasticity of the first signal terminals 10 and the second signal terminals 60. The first power terminal 6 and the second power terminal 56 make contact with each other due to the elasticity of the first power terminal 6 and the second power terminal 56. The first ground terminal 8 and the second ground terminal 58 make contact with each other due to the elasticity of the first ground terminal 8 and the second ground terminal 58.

Also, in the first embodiment as illustrated in FIG. 7(c), the second signal terminals 60 bend to a side separating from the grounded part 12 at the prescribed positions P3 which are closer to the second opening 521 than the position of the grounded part 12 in the connected state CS. Accordingly, in the connected state CS, the grounded part 12 can be easily separated from the second signal terminals 60 using a simple structure. As a result, transmission of the signal voltages between the first signal terminals 10 and the second signal terminals 60 can avoid being obstructed by the grounded part 12.

Specifically, in the connected state CS, the non-contact parts 603 of the second signal terminals 60 extend along the second direction DC while separating from the grounded part 12. Accordingly, the non-contact parts 603 are separated from the grounded part 12 and the first signal terminals 10. In particular, the non-contact parts 603 are out of contact with the grounded part 12 because the non-contact parts 603 are covered with the second holding body 54 (FIG. 6). In the connected state CS, the contact parts 601 are in contact with the first signal terminals 10 while separating from the grounded part 12. Note that the first opening 21 of the first frame body 2 is larger than the periphery of the second opening 521 of the second frame body 52. Accordingly, the second connector 200 is fitted into the first connector 100.

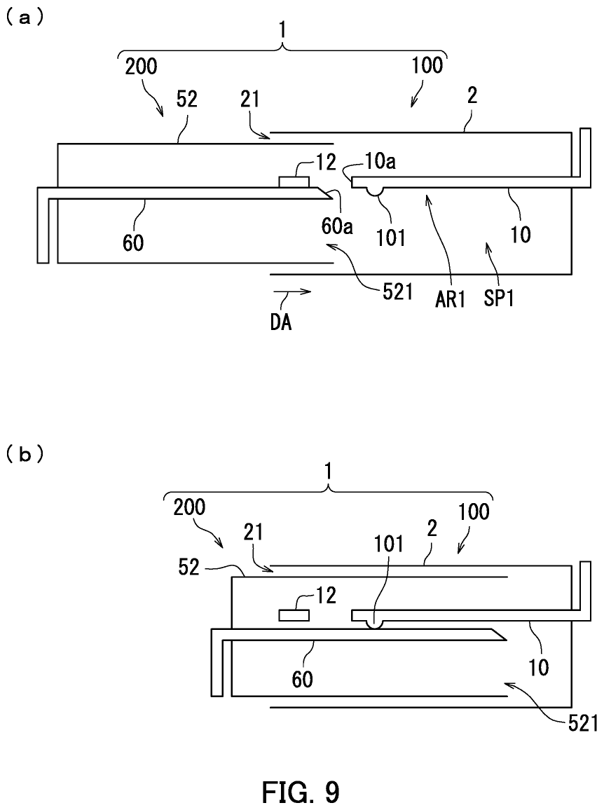

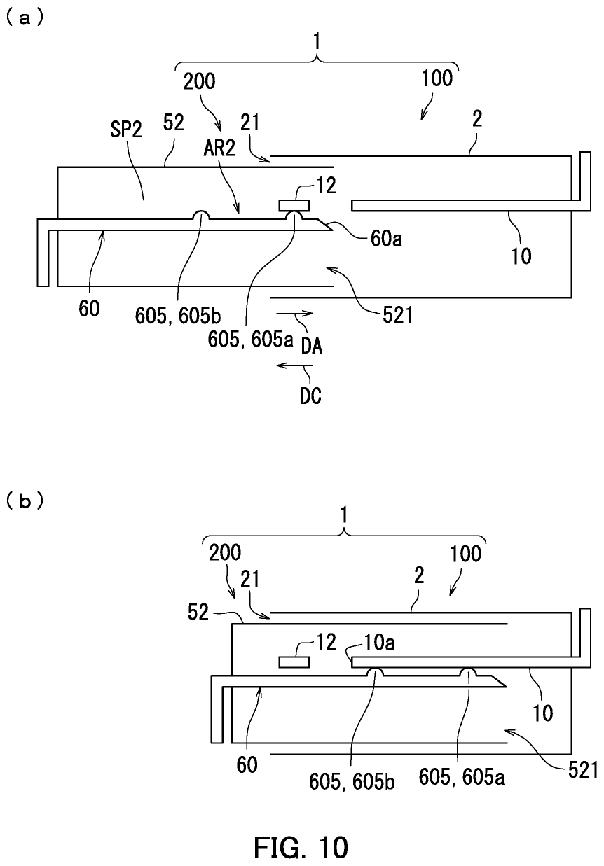

Next, a first variation and a second variation of the first embodiment are described with reference to FIGS. 9(a) to 10(b). Note that in FIGS. 9(a) to 10(b), the first holding body 4 and the second holding body 54 are omitted to facilitate viewing of the drawings.

(First Variation)

A connector device 1 according to the first variation of the first embodiment is described with reference to FIGS. 9(a) and 9(b). The connector device 1 according to the first variation mainly differs from the first variation described with reference to FIGS. 1 to 8(c) in that the first signal terminals 10 includes first projections 101 that separate the second signal terminals 60 from the grounded part 12 in the connected state CS. In the following, differences between the first variation and the first embodiment are mainly described.

FIG. 9(a) is a schematic diagram illustrating a state in which the first connector 100 and the second connector 200 are being connected according to the first variation. FIG. 9(b) is a schematic cross-sectional view of the connected state CS in which the first connector 100 and the second connector 200 are connected according to the first variation.

As illustrated in FIG. 9(a), each of the first signal terminals 10 includes a first projection 101. The first projection 101 protrudes into the internal space SP1 of the first frame body 2. Specifically, the first projection 101 protrudes into an entry area AR1 for the second signal terminals 60 in the internal space SP1 of the first frame body 2. The first projections 101 are arranged near the ends 10a of the first signal terminals 10 in the first variation. Specifically, each first projection 101 is arranged in a front area among the front area and a back area of the respective first signal terminal 10.

Each first projection 101 is for example substantially semi-circular, substantially arcuate, or substantially polygonal (substantially triangular, for example) as viewed in cross section. The first projection 101 has a bending surface, for example. Accordingly, the second signal terminals 60 (specifically the ends 60a) can advance in the first direction DA while smoothly making contact with the first projections 101.

Here, in the state in which the first connector 100 and the second connector 200 are being connected, the second signal terminals 60 make contact with the grounded part 12 before making contact with the first signal terminals 10. Accordingly, even in a case in which the second signal terminals 60 carry static electricity, electric charge caused by the static electricity of the second signal terminals 60 can be discharged through the grounded part 12 before the first signal terminals 10 make contact with the second signal terminals 60.

When the second connector 200 is further moved in the first direction DA, the state of the connector device 1 becomes the connected state CS as illustrated in FIG. 9(b). In the connected state CS, the first projections 101 are in contact with the second signal terminals 60. In particular, the first projections 101 and the second signal terminals 60 are in contact with each other due to the elasticity of the first signal terminals 10 and the second signal terminals 60. That is, the first projections 101 make contact with the second signal terminals 60.

Also in the connected state CS, the first projections 101 separate the second signal terminals 60 from the grounded part 12. Therefore, according to the first variation, the signal voltages can be transmitted from the first signal terminals 10 to the second signal terminals 60 and the signal voltages can be transmitted from the second signal terminals 60 to the first signal terminals 10 in the connected state CS even when the first connector 100 includes the grounded part 12.

Note that in the first variation, the second signal terminals 60 may not include bending parts 602 and non-contact parts 603 (FIG. 6) as in the first embodiment because the first projections 101 separate the second signal terminals 60 from the grounded part 12 in the connected state CS. Accordingly, in the first variation, the second signal terminals 60 can be separated from the grounded part 12 using a simple configuration such as the first projections 101.

(Second Variation)

A connector device 1 according to a second variation of the first embodiment is described with reference to FIGS. 10(a) and 10(b). The second variation mainly differs from the first variation described with reference to FIGS. 1 to 8(c) in that in the connector device 1 according to the second variation, the second signal terminals 60 include second projections 605 that separate the second signal terminals 60 from the grounded part 12 in the connected state CS. In the following, differences between the second variation and the first embodiment are mainly described.

FIG. 10(a) is a schematic cross-sectional view of a state in which the first connector 100 and the second connector 200 are being connected according to the second variation. FIG. 10(b) is a schematic cross-sectional view of the connected state CS in which the first connector 100 and the second connector 200 are connected according to the second variation.

As illustrated in FIG. 10(a), each of the second signal terminals 60 includes a plurality of second projections 605. In the second variation, each of the second signal terminals 60 includes two second projections 605. A second projection 605 near the second opening 521 among the two second projections 605 may be referred to as a second projection 605a, and a second projection 605 far from the second opening 521 may be referred to as a second projection 605b.

Each of the second projections 605 protrudes into the internal space SP2 of the second frame body 52. Specifically, each of the second projections 605 protrudes into an entry area AR2 for the first signal terminals 10 in the internal space SP1 of the second frame body 52. The second projections 605a are arranged near the ends 60a of the second signal terminals 60 in the second variation. Specifically, the second projections 605a are arranged in front areas among front and back areas of the second signal terminals 60. The second projections 605b are arranged in a position further away from the ends 60a of the second signal terminals 60 than the second projections 605a in the second direction DC. Each of the second projections 605a and the second projections 605b may be shaped in the same manner as the shape of the first projections 101 according to the first variation.

Here, the second signal terminals 60 (second projections 605a, for example) make contact with the grounded part 12 before making contact with the first signal terminals 10 in the state in which the first connector 100 and the second connector 200 are being connected. Accordingly, even in a case in which the second signal terminals 60 carry static electricity, electric charge caused by the static electricity of the second signal terminals 60 can be discharged through the grounded part 12 before the first signal terminals 10 make contact with the second signal terminals 60.

When the second connector 200 is further moved in the first direction DA, the state of the connector device 1 becomes the connected state CS as illustrated in FIG. 10(b). In the connected state CS, the second projections 605a and the second projections 605b are in contact with the first signal terminals 10. In particular, the second projections 605a and the second projections 605b are in contact with the first signal terminals 10 due to the elasticity of the first signal terminals 10 and the second signal terminals 60. That is, the second projections 605a and the second projections 605b make contact with the first signal terminals 10.

Also in the connected state CS, the second projections 605a and the second projections 605b separate the second signal terminals 60 from the grounded part 12. Therefore, according to the second variation, the signal voltages can be transmitted from the first signal terminals 10 to the second signal terminals 60 and the signal voltages can be transmitted from the second signal terminals 60 to the first signal terminals 10 in the connected state CS even when the first connector 100 includes the grounded part 12.

In particular, the second projections 605b are positioned near the ends 10a of the first signal terminals 10 in the connected state CS. Accordingly, the second projections 605b are positioned in positions relatively near the grounded part 12. As a result, the second signal terminals 60 can be reliably separated from the grounded part 12 in the connected state CS even in a case in which the second signal terminals 60 are elastic.

Note that in the second variation, the second signal terminals 60 may not include bending parts 602 and non-contact parts 603 (FIG. 6) as in the first embodiment because the second projections 605 separate the second signal terminals 60 from the grounded part 12 in the connected state CS. Accordingly, in the second variation, the second signal terminals 60 can be separated from the grounded part 12 using a simple configuration such as the second projections 605.

### Second Embodiment

A connector device 1A according to a second embodiment of the present invention is described with reference to FIGS. 1l to 13(c). The second embodiment mainly differs from the first embodiment in that the connector device 1A according to the second embodiment includes a grounded part 31 which protrudes from an inner surface F of the first frame body 2. In the following, differences between the second embodiment and the first embodiment are mainly described.

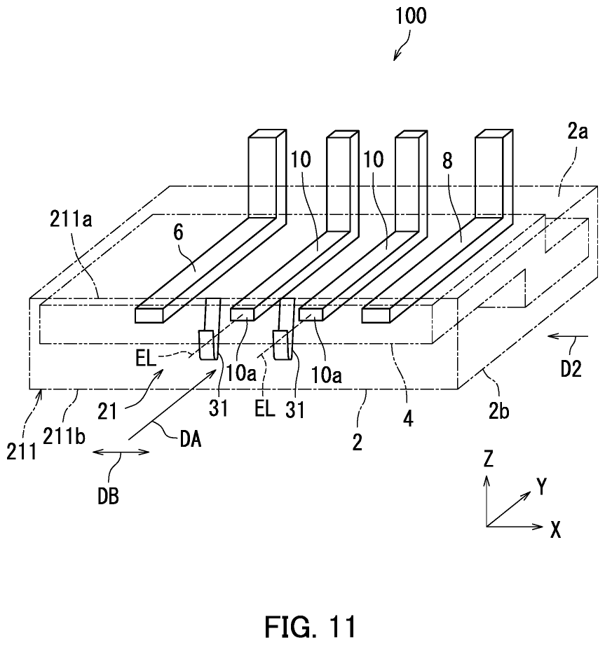

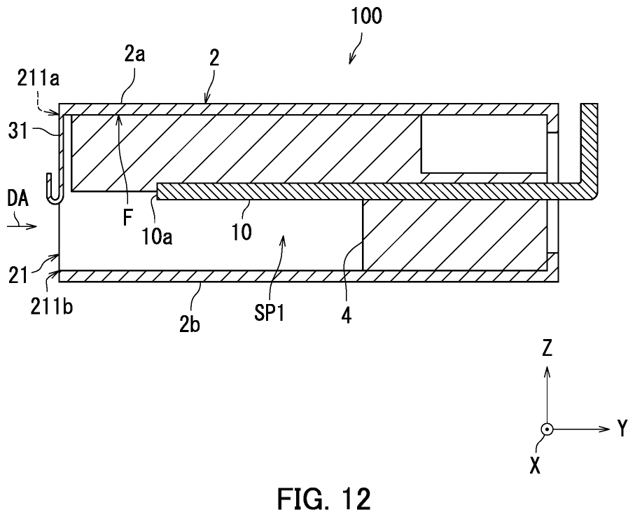

First, the first connector 100 of the connector device 1A according to the second embodiment is described with reference to FIGS. 11 and 12. FIG. 11 is a perspective view of the first connector 100. In FIG. 11, the first frame body 2 is illustrated as a dashed and dotted line and the first holding body 4 is illustrated as a dashed and double dotted line to facilitate viewing of the drawing. FIG. 12 is a cross-sectional view of the first connector 100. FIG. 12 illustrates a cross section of the first connector 100 as viewed in a direction D2 in FIG. 11.

As illustrated in FIGS. 11 and 12, the first connector 100 according to the second embodiment includes a plurality of grounded parts 31 instead of the grounded part 12 (FIG. 1) of the first connector 100 according to the first embodiment. The grounded parts 31 correspond to the respective first signal terminals 10. In the second embodiment, the first connector 100 includes two grounded parts 31. The two grounded parts 31 correspond to the two respective first signal terminals 10. Note that FIG. 12 illustrates a cross section of the first signal terminals 10 and the grounded parts 31 taken in parallel to the YZ plane.

The grounded parts 31 are grounded. When the grounded parts 31 are grounded, the grounded parts 31 have a ground potential. The material of the grounded parts 31 is a conductive material. The grounded parts 31 are made of metal, for example. The grounded parts 31 are bent substantially plate-shaped members. Specifically, the grounded parts 31 are substantially J-shaped in cross section and are configured as leaf springs.

Here, the first frame body 2 is described to describe the grounded parts 31 in detail. The first frame body 2 includes a first frame element 2a and a second frame element 2b which are opposite to each other. The first frame element 2a and the second frame element 2b are substantially flat and substantially rectangular. The first power terminal 6, the first signal terminals 10, and the first ground terminal 8 are exposed toward the second frame element 2b in the internal space SP1 of the first frame body 2.

The first opening 21 of the first frame body 2 has a substantially rectangular opening edge 211. The opening edge 211 includes a first edge 211a and a second edge 211b which are opposite to each other. The first edge 211a is an edge on the first opening 21 side of the first frame element 2a. The second edge 211b is an edge on the first opening 21 side of the second frame element 2b.

The grounded parts 31 protrude from the inner surface F of the first frame body 2 (specifically, the first frame element 2a). Specifically, the grounded parts 31 protrude toward the first opening 21 from the opening edge 211 of the first frame body 2. More specifically, the grounded parts 31 protrude toward the second edge 211b from the first edge 211a of the opening edge 211. In the second embodiment, the grounded parts 31 protrude toward a side of the second edge 211b relative to the first signal terminals 10. The grounded parts 31 are arranged in front of the first signal terminals 10. The grounded parts 31 and the ends 10a of the first signal terminals 10 are opposite to each other with intervals therebetween.

In the second embodiment, the grounded parts 31 and the first frame body 2 are an integrated piece. Accordingly, the number of components of the first connector 100 can be reduced. As a result, the manufacturing cost of the first connector 100 can be reduced. Furthermore, the grounded parts 31 are grounded through the first frame body 2 because the first frame body 2 is grounded.

Note that the configuration of the second connector 200 of the connector device 1A according to the second embodiment is the same as the configuration of the second connector 200 according to the first embodiment described with reference to FIGS. 4 to 6. However, in the second embodiment, the first connector 100 is fitted into the second connector 200. Accordingly, the second opening 521 of the second frame body 52 of the second connector 200 is larger than a periphery of the first opening 21 of the first frame body 2. Furthermore, a suitable gap is formed between the second frame body 52 and the second holding body 54 because the first connector 100 is fitted to the inside of the second connector 200.

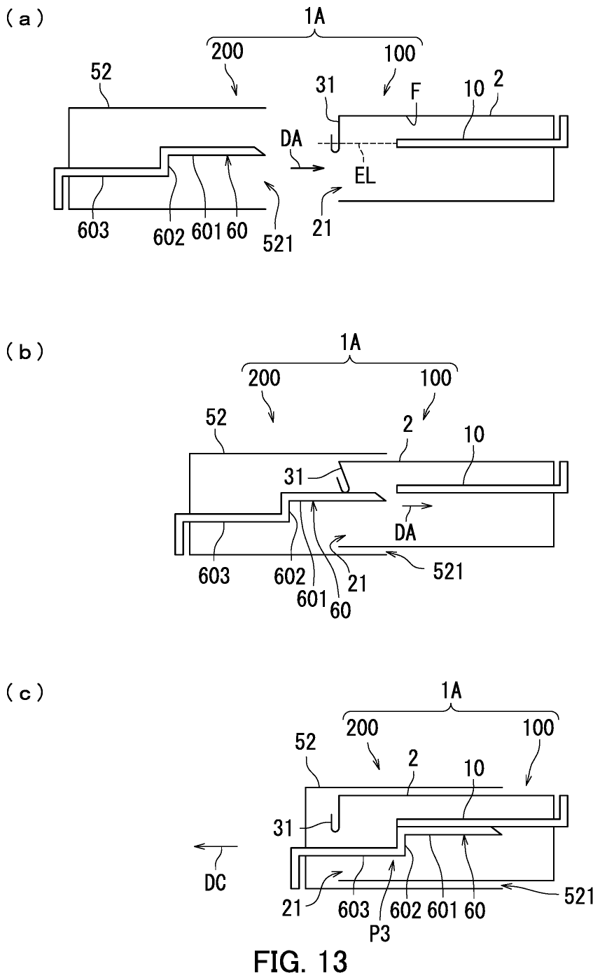

Similarly to the first embodiment, the second connector 200 is inserted in the first frame body 2 through the first opening 21. In particular, in the second embodiment, a portion of the second connector 200 is inserted in the first frame body 2 through the first opening 21. That is, “the second connector 200 being inserted through the first opening 21” includes “a portion of the second connector 200 being inserted through the first opening 21”. A “portion of the second connector 200” is for example the second signal terminals 60, the second power terminal 56, and the second ground terminal 58 as illustrated in FIG. 5. For example, as illustrated in the later-described FIGS. 13(a) to 15(b), the second signal terminals 60 of the second connector 200 are inserted in the first frame body 2 through the first opening 21. Note that though not illustrated in FIGS. 13(a) to 15(b), the second power terminal 56 and the second ground terminal 58 of the second connector 200 are inserted in the first frame body 2d through the first opening 21.

Next, a process from a state in which the first connector 100 and the second connector 200 are separated to the connected state CS is described with reference to FIGS. 13(a) to 13(c). FIG. 13(a) is a schematic cross-sectional view of the state in which the first connector 100 and the second connector 200 are separated. FIG. 13(b) is a schematic cross-sectional view of a state in which the first connector 100 and the second connector 200 are being connected. FIG. 13(c) is a schematic cross-sectional view of the connected state CS in which the first connector 100 and the second connector 200 are connected. Note that in FIGS. 13(a) to 13(c), the first holding body 4 and the second holding body 54 are omitted to facilitate viewing of the drawings.

As illustrated in FIG. 13(a), the first connector 100 and the second connector 200 are separated. The second connector 200 is then moved toward the first connector 100 in the first direction DA.

As illustrated in FIG. 13(b), the second signal terminals 60 of the second connector 200 then pass through the first opening 21 of the first connector 100. By contrast, the grounded parts 31 of the first connector 100 are located on the side of the first opening 21 relative to the first signal terminals 10. Accordingly, the second signal terminals 60 make contact with the grounded parts 31 before making contact with the first signal terminals 10.

Specifically, the grounded parts 31 make contact with the second signal terminals 60 after insertion of the second connector 200 to the first frame body 2 has begun but before the connected state CS is reached in which the first signal terminals 10 and the second signal terminals 60 are connected at completion of the insertion. In other words, the second signal terminals 60 make contact with the grounded parts 31 after the insertion of the second connector 200 to the first frame body 2 has begun but before the connected state CS is reached.

As a result, in a case in which even the second signal terminals 60 carry static electricity, electric charge caused by the static electricity of the second signal terminals 60 can be discharged through the grounded parts 31 before the first signal terminals 10 make contact with the second signal terminals 60. Therefore, the electronic device to which the first connector 100 is installed can be protected from electrostatic discharge. Furthermore, similarly to the first embodiment, the manufacturing cost of the connector device 1A (first connector 100 and second connector 200) can be reduced as compared to a case in which electronic components for countering electrostatic discharge are included because it is sufficient for the first connector 100 to include the grounded parts 31 as components for protecting the electronic device from electrostatic discharge.

Note that the grounded parts 31 and the second signal terminals 60 are in contact with each other due to the elasticity of the grounded parts 31 and the second signal terminals 60.

Furthermore, in the second embodiment, the grounded parts 31 protrude from the inner surface F of the first frame body 2 as illustrated in FIG. 13(a). Accordingly, as illustrated in FIG. 13(b), the second signal terminals 60 easily make contact with the grounded parts 31 before making contact with the first signal terminals 10. As a result, electric charge caused by static electricity of the second signal terminals 60 can be easily discharged through the grounded parts 31 and the electronic device to which the first connector 100 is installed can be protected from electrostatic discharge. In particular, the second signal terminals 60 can be further easily brought into contact with the grounded parts 31 before the first signal terminals 10 make contact with the second signal terminals 60 because the grounded parts 31 are arranged in the extension area EA (on the extension line EL in the second embodiment) from the first signal terminals 10 (FIGS. 11 and 13(a)). As a result, electric charge caused by static electricity of the second signal terminals 60 can be further easily discharged through the grounded parts 31. Furthermore, force accompanying the contact of the second signal terminals 60 to the grounded parts 31 can be prevented from acting on the first ground terminal 8 because the grounded parts 31 are separated from the first ground terminal 8 (FIG. 11). As a result, the durability of the first ground terminal 8 can be improved.

When the second connector 200 is further moved in the first direction DA as illustrated in FIG. 13(b), the state of the connector device 1A becomes the connected state CS as illustrated in FIG. 13(c).

That is, the two second signal terminals 60 are in contact with the two respective first signal terminals 10 in the connected state CS. In addition, the second signal terminals 60 are separated from the grounded parts 31 of the first connector 100 in the connected state CS. In other words, the grounded parts 31 are arranged to be separated from the second signal terminals 60 in the connected state CS in which the first signal terminals 10 and the second signal terminals 60 are connected. In yet other words, the second signal terminals 60 are separated from the grounded parts 31 in the connected state CS. Therefore, according to the second embodiment, in the connected state CS, the signal voltages can be transmitted from the first signal terminals 10 to the second signal terminals 60 and the signal voltages can be transmitted from the second signal terminals 60 to the first signal terminals 10 even when the first connector 100 includes the grounded parts 31.

In the second embodiment, the second signal terminals 60 are bent to a side away from the grounded parts 31 at the prescribed positions P3 which are closer to the second opening 521 than the positions of the grounded parts 31 in the connected state CS.

Note that as illustrated in FIG. 13(b), the second signal terminals 60 push the grounded parts 31 inside the first frame body 2. However, as illustrated in FIG. 13(c), the grounded parts 31 return to their original positions due to the elasticity of the grounded parts 31 in the connected state CS.

(First Variation)

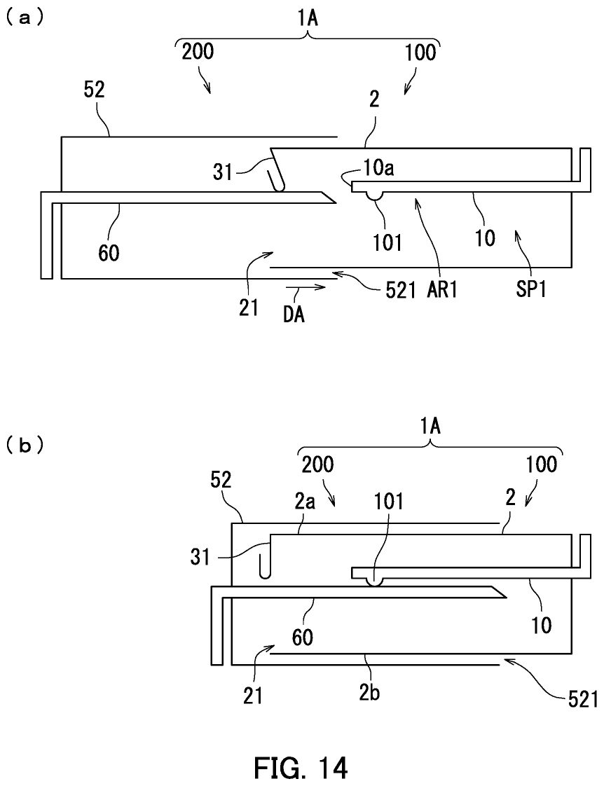

A connector device 1A according to a first variation of the second embodiment is described with reference to FIGS. 14(a) and 14(b). The first variation mainly differs from the second embodiment described with reference to FIGS. 11 to 13(c) in that the connector device 1A according to the first variation includes the first projections 101 according to the first variation of the first embodiment described with reference to FIGS. 9(a) and 9(b). In the following, differences of the first variation from the first variation of the first embodiment and the second embodiment are mainly described.

As illustrated in FIG. 14(a), the second signal terminals 60 make contact with the grounded parts 31 before making contact with the first signal terminals 10 in a state in which the first connector 100 and the second connector 200 are being connected.

The second connector 200 is then further moved in the first direction DA and the first projections 101 of the first signal terminals 10 make contact with the second signal terminals 60 as the state of the connector device 1 becomes the connected state CS as illustrated in FIG. 14(b). Furthermore, the first projections 101 separate the second signal terminals 60 from the grounded parts 31 in the connected state CS.

In particular, in the first variation, the first projections 101 protrude more to the side of the second frame element 2b than the grounded parts 31 in the connected state CS. As a result, the second signal terminals 60 can be reliably separated from the grounded parts 31 in the connected state CS.

(Second Variation)

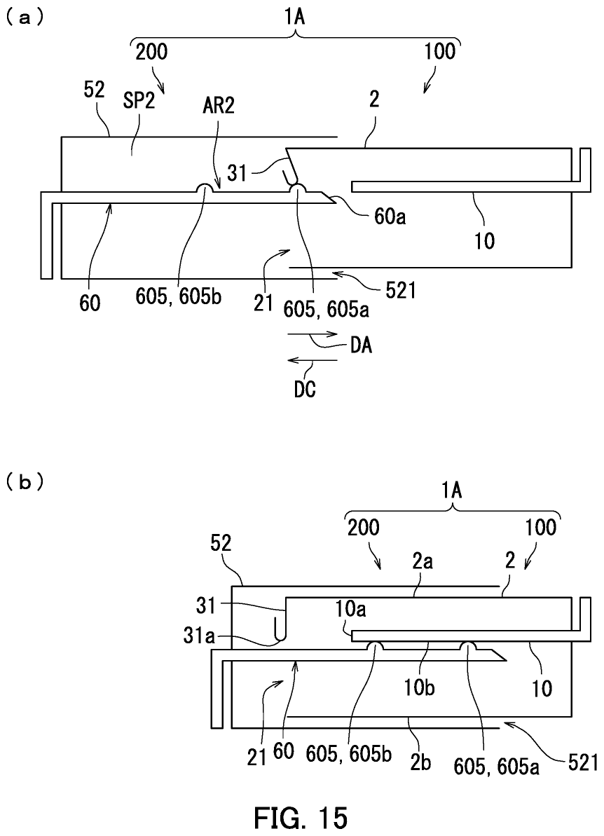

A connector device 1A according to a second variation of the second embodiment is described with reference to FIGS. 15(a) and 15(b). The second variation mainly differs from the second embodiment described with reference to FIGS. 11 to 13(c) in that the connector device 1A according to the second variation includes the second projections 605 according to the second variation of the first embodiment described with reference to FIGS. 10(a) and 10(b). In the following, differences of the second variation from the second variation of the first embodiment and the second embodiment are mainly described.

As illustrated in FIG. 15(a), the second signal terminals 60 (second projections 605a, for example) make contact with the grounded parts 31 before making contact with the first signal terminals 10 in a state in which the first connector 100 and the second connector 200 are being connected.

The second connector 200 is then further moved in the first direction DA and the second projections 605a and the second projections 605b make contact with the first signal terminals 10 as the state of the connector device 1A becomes the connected state CS as illustrated in FIG. 15(b). Furthermore, the second projections 605a and the second projections 605b separate the second signal terminals 60 from the grounded parts 31 in the connected state CS.

In particular, in the second variation, tips 31a of the grounded parts 31 are flush to exposed surfaces 10b of the first signal terminals 10, or are positioned slightly closer to the side of the first frame element 2a than the exposed surfaces 10b of the first signal terminals 10 in the connected state CS. As a result, the second signal terminals 60 can be reliably separated from the grounded parts 31 in the connected state CS.

(Third Variation)

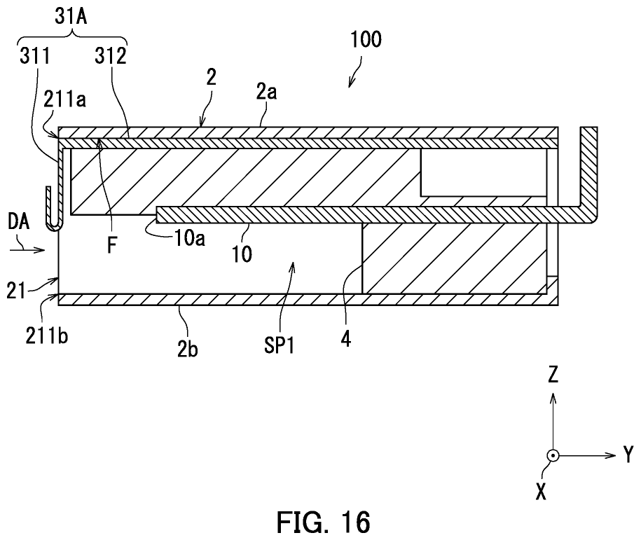

A connector device 1A according to a third variation of the second embodiment is described with reference to FIG. 16. The third variation mainly differs from the second embodiment described with reference to FIGS. 11 to 13(c) in that the connector device 1A according to the third variation includes grounded parts 31A as discrete members of the first frame body 2. In the following, the differences between the third variation and the second embodiment are mainly described.

FIG. 16 is a cross-sectional view of the first connector 100 of the connector device 1A according to the third variation. As illustrated in FIG. 16, the first connector 100 according to the third variation includes grounded parts 31A (a plurality of grounded parts 31A) instead of the grounded parts 31 (a plurality of grounded parts 31) illustrated in FIG. 12. The material of the grounded parts 31A is the same as the material of the grounded parts 31. The grounded parts 31A are grounded. When the grounded parts 31A are grounded, the grounded parts 31A have a ground potential. In the third variation, the grounded parts 31A are in contact with the first frame body 2. Accordingly, the grounded parts 31A are grounded through the first frame body 2.

Specifically, each of the grounded parts 31A includes a protrusion 311 and a supporting part 312. The supporting part 312 supports the protrusion 311. The supporting part 312 is substantially flat plate-shaped, and extends along the inner surface F of the first frame element 2a. The supporting part 312 is sandwiched by the first frame element 2a and the first holding body 4. The supporting part 312 is placed inside the first frame body 2. In the third variation, the supporting part 312 and the protrusion 311 are an integrated piece.

The protrusions 311 protrude from the inner surface F of the first frame body 2 (specifically the first frame element 2a). Otherwise, the configuration of the protrusions 311 is the same as the configuration of the grounded parts 31 illustrated in FIG. 12. In addition, the function and action of the protrusions 311 is the same as the function and action of the grounded parts 31 illustrated in FIG. 12. Accordingly, the second signal terminals 60 (FIG. 13(b)) of the second connector 200 make contact with the protrusions 311 before making contact with the first signal terminals 10. As a result, in the third variation, electric charge caused by static electricity of the second signal terminals 60 can be discharged through the protrusions 311 and the electronic device to which the first connector 100 is installed can be protected from electrostatic discharge.

In the third variation, even in a case in which forming the grounded parts 31 (FIG. 12) on the first frame body 2 is difficult, electrostatic discharge can be easily countered by arranging the grounded parts 31A on the first frame body 2. In addition, in the third variation, force accompanying the contact between the grounded parts 31A and the second signal terminals 60 can be prevented from acting on the first ground terminal 8 because the grounded parts 31A are separated from the first ground terminal 8 (FIG. 11). As a result, the durability of the first ground terminal 8 can be increased.

Embodiments of the present invention are described above with reference to the accompanying drawings. However, the present invention is not limited to the above embodiments and may be implemented in various manners with in a scope not departing from the gist thereof (as described below in (1) and (2), for example). Furthermore, various inventions may be formed by appropriately combining constituent elements disclosed in the above embodiments. For example, some constituent elements may be removed from all of the constituent elements illustrated in the embodiments. Additionally, constituent elements may be appropriately combined across different embodiments. The drawings mainly illustrate the constituent elements schematically to facilitate understanding thereof. Aspects such as thickness, length, number, and interval of the constituent elements illustrated in the drawings may differ in practice for convenience of drawing preparation. Furthermore, aspects such as material, shape, and dimension of the constituent elements illustrated in the above embodiments are examples and not particular limitations. The constituent elements may be variously altered within a scope not substantively departing from the effects of the present invention.

(1) In the first embodiment (including variations) and the second embodiment (including variations), as long as the grounded part 12, the grounded parts 31, or the grounded parts 31A (may each be referred to generically in the following as a “grounded part GND”) are arranged on the side of the first opening 21 relative to the first signal terminals 10, the first connector 100 may include a single grounded part GND and the shape of the grounded part GND is not particularly limited. Furthermore, the grounded part 12 (FIG. 1) may be separated from the first ground terminal 8 as long as the grounded part 12 is grounded. In addition, the grounded parts 31 (FIG. 11) or the protrusions 311 (FIG. 16) may be arranged inside the first frame body 2. Furthermore, the connector devices 1 and 1A may not conform to the USB standard. In addition, the ends 60a (FIG. 4) of the second signal terminals 60 may not be inclined.

(2) In the first variation of the first embodiment and the first variation of the second embodiment, the first signal terminals 10 may each include a plurality of first projections 101 (FIGS. 9(a) and 14(a)). In the second variation of the first embodiment and the second variation of the second embodiment, the second signal terminals 60 may each include a single second projection 605 (FIGS. 10(a) and 15(a)), or may each include three or more second projections 605.

### INDUSTRIAL APPLICABILITY

The present invention provides a first connector, a second connector, and a connector device, and has industrial applicability.

### REFERENCE SIGNS LIST

1 Connector device
2 First frame body
8 First ground terminal
First signal terminal
12, 31, 31A Grounded part
21 First opening
52 Second frame body
58 Second ground terminal
60 Second signal terminal
100 First connector
101 First projection
200 Second connector
311 Protrusion
312 Supporting part
521 Second opening
605 Second projection

1. A first connector to be connected to a second connector, the first connector comprising:
a first frame body having a first opening, the second connector to be inserted into the first frame body through the first opening;
a first signal terminal arranged inside the first frame body, and configured to be connected to a second signal terminal included in the second connector; and
a grounded part arranged to make contact with the second signal terminal after insertion of the second connector to the first frame body has begun but before a connected state is reached in which the first signal terminal and the second signal terminal are connected at completion of the insertion, and separate from the second signal terminal in the connected state, wherein
the first signal terminal linearly extends along an insertion direction of the second connector, and
the grounded part is arranged in an area of an extension where the first signal terminal is extended along the insertion direction, toward the first opening from an end of the first signal terminal on a side of the first opening.

2. (canceled)

3. The first connector according to claim 1, further comprising
a first ground terminal arranged inside the first frame body, and configured to be connected to a second ground terminal included in the second connector in the connected state, wherein
the first ground terminal includes a first part extending along the insertion direction of the second connector and a second part extending from an end on the side of the first opening of the first part so as to pass between the first opening and the first signal terminal, and
the second part composes the grounded part.

4. The first connector according to claim 1, wherein
the grounded part protrudes from an inner surface of the first frame body.

5. The first connector according to claim 4, wherein
the grounded part and the first frame body are an integrated piece.

6. The first connector according to claim 4, wherein
the grounded part includes:
a protrusion protruding from the inner surface of the first frame body; and
a supporting part which supports the protrusion, and
the supporting part is placed inside the first frame body.

7. The first connector according to claim 1, wherein
the first signal terminal includes a first projection which protrudes into an internal space of the first frame body, and
in the connected state, the first projection separates the second signal terminal from the grounded part.

8. A second connector to be connected to the first connector according to claim 1, the second connector comprising
the second signal terminal, wherein
the second signal terminal makes contact with the grounded part after insertion of the second connector to the first frame body has begun but before the connected state is reached, and is separated from the grounded part in the connected state.

9. The second connector according to claim 8, further comprising
a second frame body having a second opening, wherein
the second signal terminal is arranged inside the second frame body and extends along the insertion direction of the second connector, and
the second signal terminal bends to a side separating from the grounded part at a prescribed position closer to the second opening than a position of the grounded part in the connected state.

10. The second connector according to claim 8, further comprising
a second frame body having a second opening, wherein
the second signal terminal includes a second projection which protrudes into an internal space of the second frame body, and
in the connected state, the second projection separates the second signal terminal from the grounded part.

11. (canceled)

12. A connector device comprising:
a first connector including a frame body, a first signal terminal, and a grounded part;
a second connector to be connected to the first connector, the second connector including a second signal terminal, wherein
the frame body has an opening, the second connector to be inserted into the frame body through the opening,
the first signal terminal is arranged inside the frame body, and is to be connected to the second signal terminal,
the grounded part is arranged to make contact with the second signal terminal after insertion of the second connector to the frame body has begun but before a connected state is reached in which the first signal terminal and the second signal terminal are connected at completion of the insertion, and separate from the second signal terminal in the connected state,
the first signal terminal linearly extends along an insertion direction of the second connector,
the grounded part is arranged in an area of an extension where the first signal terminal is extended along the insertion direction, toward the opening from an end of the first signal terminal on a side of the opening, and
the second signal terminal makes contact with the grounded part after the insertion of the second connector to the frame body has begun but before the connected state is reached, and is separated from the grounded part in the connected state.
